(19) United States
(12) Patent Application Publication
(10) Pub. No.: US 2012/0141932 A1
(43) Pub. Date: Jun. 7, 2012

(54) DEVELOPER AND METHOD FOR PRODUCING THE SAME

(75) Inventor: Toshiaki Yamauchi, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/310,919

(22) Filed: Dec. 5, 2011

Related U.S. Application Data
(60) Provisional application No. 61/420,564, filed on Dec. 7, 2010.

(30) Foreign Application Priority Data
Sep. 22, 2011 (JP) P2011-207091

(51) Int. Cl. G03G 9/093; G03G 9/087; G03G 9/09; G03G 9/00

(52) U.S. Cl. 430/109.3; 430/137.14; 430/105; 430/110.2; 430/109.4; 430/109.1

(57) ABSTRACT

A method for producing a developer, the method includes aggregating first fine particles and second fine particles in a dispersion liquid, said dispersion liquid containing the first fine particles which contain at least a binder resin, and the second fine particles which contain a coloring compound, a color developer and a decolorizing agent and have been subjected to a master batch treatment; and forming aggregate particles.

### CROSS-REFERENCE TO RELATED APPLICATIONS

This application is based upon and claims the benefit of priority from the prior Japanese Patent Application No. 2011-207091, filed on Sep. 22, 2011, the entire contents of which are incorporated herein by reference. Further this application is also based upon and claims the benefit of priority from the prior U.S. Provisional Application No. 61/420,564, filed on Dec. 7, 2010, the entire contents of which are incorporated herein by reference.

### FIELD

Embodiments described herein generally relate to a developer for electrophotography, and a method for producing the same.

### BACKGROUND

A method of eliminating colors from an image formed on a recording medium such as paper and reusing the recording medium, is very effective from the viewpoints of environmental protection as a result of a decrease in the amount of use of the recording medium, and economic efficiency.

In regard to color materials that can be eliminated, there are known color materials which contain a coloring compound and a color developer, and can be eliminated by heating. As to methods for producing such a color material that can be eliminated, chemical production methods are used in recent years, in addition to the kneading pulverization methods that have been conventionally used.

In a chemical production method, color material particles are produced by aggregating a color material that can be eliminated, together with fine resin particles, and heating and fusing the aggregates.

However, since resin particles and a color material have different chemical affinities, it is difficult to produce uniform aggregates, and also, when the aggregates are heated and fused, aggregation occurs in the resin only so that the color material tends to precipitate out easily. Thus, it has been difficult to obtain a toner in which a color material is uniformly dispersed in a resin.

### BRIEF DESCRIPTION OF THE DRAWINGS

FIG. 1 is a flow diagram showing an example of a method for producing a developer according to an embodiment;

FIG. 2 is a model diagram of the method for producing a developer as shown in FIG. 1;

FIG. 3 is a model diagram showing a modification of the developer;

FIG. 4 is a schematic diagram of a high pressure type wet atomizer used in the embodiment; and

FIG. 5 is a schematic configuration diagram of an image forming apparatus to which the developer according to the embodiment can be applied.

### DETAILED DESCRIPTION

In view of the above circumstances, an aspect of the embodiments provide a method for producing a developer capable of color elimination, in which a color material and resin particles are uniformly dispersed.

The method for producing a developer for electrophotography according to an embodiment includes aggregating first fine particles and second fine particles in a dispersion liquid, said dispersion liquid containing the first fine particles which contain at least a binder resin, and the second fine particles which contain a coloring compound, a color developer and a decolorizing agent and have been subjected to a master batch treatment; and forming aggregate particles

An aspect of other embodiments provide a developer obtained by aggregating first fine particles and second fine particles in a dispersion liquid containing the first fine particles that contain at least a binder resin and the second fine particles that contain a coloring compound, a color developer and a decolorizing agent and have been subjected to a master batch treatment, and forming aggregate particles.

Hereinafter, embodiments will be described with reference to the attached drawings.

In a method for producing a developer according to an embodiment, first fine particles which contain at least a binder resin, and second fine particles which contain a coloring compound, a color developer and a decolorizing agent, and have been subjected to a master batch treatment, are separately produced. The second fine particles are preliminarily dispersed by the master batch treatment. Subsequently, a dispersion liquid containing the first fine particles and the second fine particles is aggregated, and thereby, aggregate particles are formed. Thereafter, for example, the aggregate particles are fused by raising the temperature, and the fused particles thus obtained are washed and dried. Thus, toner particles can be formed.

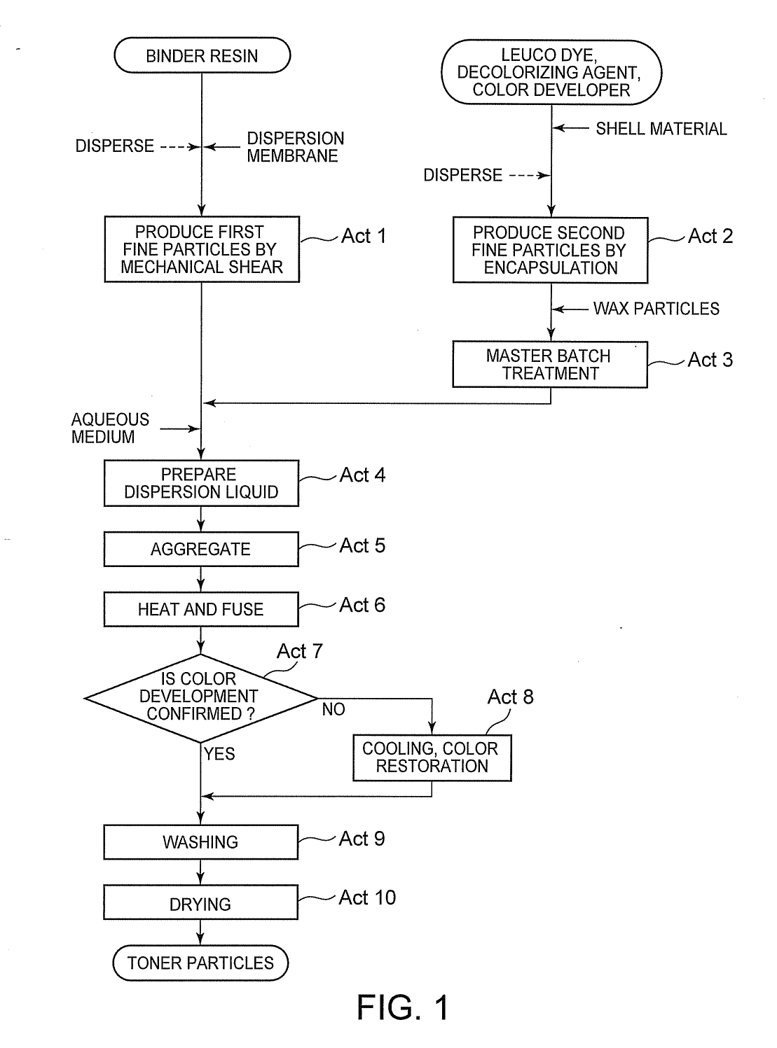

FIG. 1 presents a flow chart showing the method for producing a developer according to an embodiment of the present invention.

For example, the first fine particles can be formed by subjecting a dispersion liquid of resin particles containing at least a binder resin to mechanical shear, and micronizing these resin particles to obtain fine particles having a particle size smaller than the particle size of the resin particles (Act 1).

The second fine particles (color material) are formed by preparing a core component containing a coloring compound, a color developer and a decolorizing agent, and encapsulating this core component with a shell component (Act 2).

As the coloring compound, for example, a leuco dye that is decolorized when heated to a temperature equal to or higher than the decolorization temperature, and develops a color when cooled to a temperature equal to or lower than the color restoration temperature, can be used as a representative material.

Examples of the method of encapsulation include an interface polymerization method, a coacervation method, an in situ polymerization method, an in-liquid drying method, and an in-liquid film curing method.

Particularly, an in situ polymerization method of using a melamine resin as a shell component, an interface polymerization method of using a urethane resin as a shell component, and the like are preferable.

In the case of the in situ polymerization method, first, the coloring compound, color developer and decolorizing agent described above are dissolved and mixed, and the solution is emulsified in an aqueous solution of a water-soluble polymer or a surfactant. Subsequently, an aqueous solution of a melamine-formalin prepolymer is added thereto, and the resulting mixture is polymerized by heating. Thereby, the core component can be encapsulated.

In the case of the interface polymerization method, the three components described above and a polyvalent isocyanate prepolymer are dissolved and mixed, and the solution is emulsified in an aqueous solution of a water-soluble polymer or a surfactant. Subsequently, a polyvalent base such as a diamine or a diol is added thereto, and the resulting mixture is polymerized by heating. Thereby, the core component can be encapsulated.

Next, the second fine particles that have been encapsulated with a shell component are subjected to a master batch treatment (Act 3). According to the present embodiment, the master batch treatment involves preliminarily dispersing the second fine particles by melt kneading the encapsulated second fine particles and a binder resin, and thereby forming a master batch.

As an example of the method for preparing a master batch, there may be mentioned a method of mixing encapsulated second fine particles and a binder resin and melt kneading the mixture with a three-roll mill at a temperature lower than the decolorization temperature. Melt kneading can also be performed using other kneading machines such as a two-roll mill, a pressure kneader, a twin-screw extruder, a Kneadex, and a Banbury mixer.

There are no particular limitations on the type of the binder resin that is used at the time of preparation of the master batch, but it is preferable to select a material which can be mixed and kneaded with the second fine particles at a low temperature and has high affinity for both the first fine particles and the second fine particles. It is also preferable that the binder resin have a melting point lower than the fixing temperature.

Examples of the material that can be used with preference as the binder resin include a low molecular weight polyethylene wax, a polypropylene wax, a paraffin wax, and an ester wax.

Next, a dispersion liquid containing the first fine particles obtained in Act 1, the encapsulated and master batch-treated second fine particles, and an aqueous medium, is prepared (Act 4).

The first fine particles and the second fine particles are aggregated (Act 5).

The aggregated particles are further heated and fused (Act 6).

Heating and fusion can be carried out, for example, at a temperature in the range of from 40° C. to 95° C. The binder resin, the releasing agent and the like can be selected so that the fine particles can be fused in this temperature range.

The color development temperature of the leuco dye of the fused particle is checked (Act 7), and if the color of the leuco dye has not developed (No for Act 7), the fused particles are further cooled to the color restoration temperature (Act 8) On the other hand, if the color of the leuco dye has developed (Yes for Act 7), the procedure goes to Act 9.

The fused particles thus obtained are washed (Act 9) and dried (Act 10), and thereby toner particles can be obtained. As the washing apparatus used in Act 9, for example, a centrifuge device or a filter press may be used. As the washing liquid, for example, water, ion-exchanged water, purified water, acidically adjusted water, or basically adjusted water may be used. As the drying apparatus used in Act 10, for example, a vacuum dryer, an air jet dryer, or a fluidized dryer may be used.

According to the method for producing a developer of the present embodiment as described above, when the second fine particles, which serve as a color material, are used in a master batch-treated state, the affinity thereof for the first fine particles, which are resin particles, is enhanced. Thereby, dispersibility of the fine particles can be increased, and thus, a high-quality toner having satisfactory decolorization performance, in which the first fine particles and the second fine particles are uniformly dispersed, can be obtained.

Furthermore, when the surfaces of the second fine particles as a color material are wrapped by a master batch treatment, conduction of heat is suppressed, and the temperature at which the toner loses the color during the heat fixing of the image forming apparatus can be increased. As a result, the fixing-possible temperature range can be extended without impairing the decolorization characteristics.

Furthermore, more rapid decolorization can be achieved by encapsulating a core component containing a coloring compound, a color developer and a decolorizing agent, with a shell component.

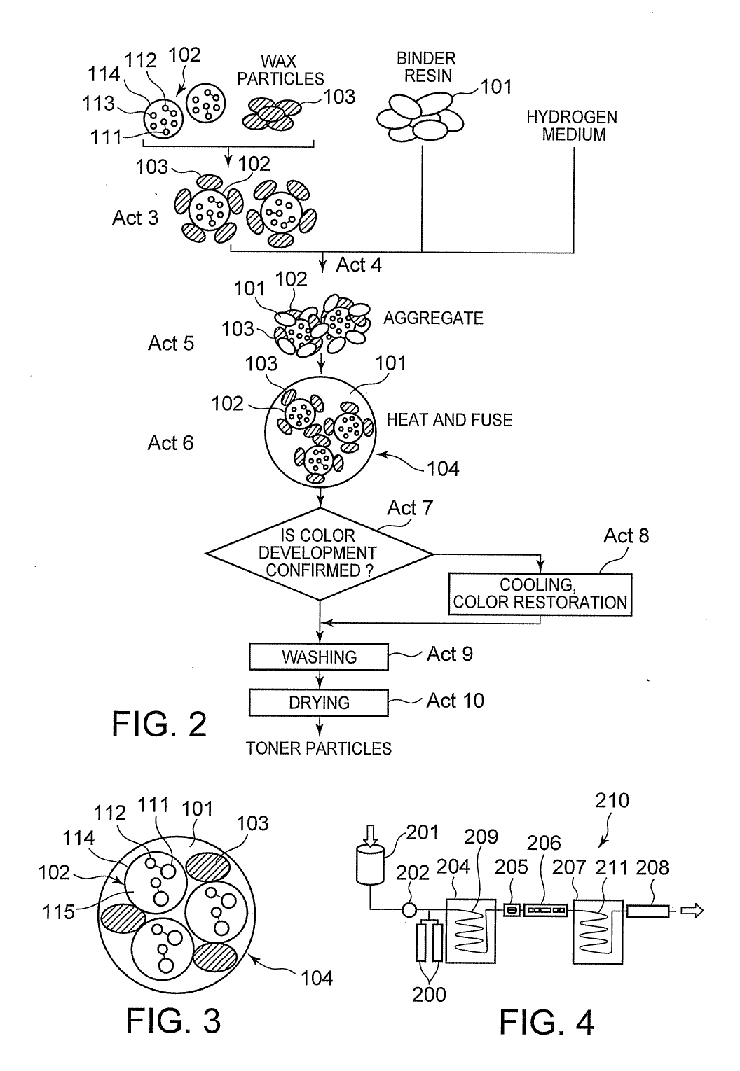

FIG. 2 is a model diagram showing a portion of an example of the method for producing a developer according to the present embodiment. In the diagram, Act 3 to 10 assigned with the same reference numerals as in FIG. 1, are defined to indicate the same processes.

As depicted in the diagram, second fine particles 102 in which a core material containing a coloring compound III such as a leuco dye, a color developer 112 and a decolorizing agent component 113 is encapsulated by a shell material 114, are mixed with wax particles 103 as an optional component, which serves as a binder resin, and thus the second fine particles are master batch-treated (Act 3)

Subsequently, first fine particles 101 containing a binder resin, and the second fine particles 102 that have been master batch-treated, are dispersed in an aqueous medium (Act 4).

Subsequently, the first fine particles 101 and the master batch-treated second fine particles 102 are aggregated in the aqueous medium (Act 5).

The aggregate particles thus obtained are heated and fused, and thereby toner particles 104 are obtained (Act 6).

In these toner particles 104, the coloring compound III and the color developer 112 are coupled with each other and develop a color. At the time of decolorization, for example, the color developer 112 is coupled with the decolorizing agent component 113, and the coupling of the coloring compound III and the color developer 112 can be decoupled.

The toner particles 104 obtained in Act 6 are subjected to Act 7 to Act 10 as shown in FIG. 1.

FIG. 3 presents a model diagram showing another example of the toner particles used in the developer of the present embodiment.

These toner particles 104′ have the same constitution as that of the toner particles 104 shown in FIG. 2, except that the toner particles 104′ contain second fine particles 102′ containing a medium 115 having a decolorizing action, instead of the decolorizing agent component 113.

The leuco dye mentioned as an example of the coloring compound, and the color develop and decolorizing agent will be described below.

The leuco dye is an electron-donating compound capable of developing a color under the action of a color developer.

Examples thereof include diphenylmethane phthalides, phenylindolyl azaphthalides, fluorans, styrynoquinolines, and diaza-rhodamine lactones.

Specific examples of the leuco dye include 3,3-bis(p-dimethylaminophenyl)-6-dimethylaminophthalide, 3-(4-diethylaminophenyl)-3-(1-ethyl-2-methylindol-3-yl)phth alide, 3,3-bis(1-n-butyl-2-methylindol-3-yl)phthalide, 3,3-bis(2-ethoxy-4-diethylaminophenyl)-4-azaphthalide, 3-(2-ethoxy-4-diethylaminophenyl)-3-(1-ethyl-2-methylindol-3-yl)-4-azaphthalide, 3-[2-ethoxy-4-(N-ethylanilino)phenyl]-3-(1-ethyl-2-methylin dol-3-yl)-4-azaphthalide, 3,6-diphenylaminofluoran, 3,6-dimethoxyfluoran, 3,6-di-n-butoxyfluoran, 2-methyl-6-(N-ethyl-N-p-tolylamino)fluoran, 2-N,N-dibenzylamino-6-diethylaminofluoran, 3-chloro-6-cyclohexylaminofluoran, 2-methyl-6-cyclohexylaminofluoran, 2-(2-chloroanilino)-6-di-n-butylaminofluoran, 2-(3-trifluoromethylanilino)-6-diethylaminofluoran, 2-(N-methylanilino)-6-(N-ethyl-N-p-tolylamino)fluoran, 1,3-dimethyl-6-diethylaminofluoran, 2-chloro-3-methyl-6-diethylaminofluoran, 2-anilino-3-methyl-6-diethylaminofluoran, 2-anilino-3-methyl-6-di-n-butylaminofluoran, 2-xylidino-3-methyl-6-diethylaminofluoran, 1,2-benz-6-diethylaminofluoran, 1,2-benz-6-(N-ethyl-N-isobutylamino)fluoran, 1,2-benz-6-(N-ethyl-N-isoamylamino)fluoran, 2-(3-methoxy-4-dodecoxystyryl)quinoline-spiro[5H-(1)benzopyrano (2,3-d)pyrimidine-5,1′(3′H)isobenzofuran]-3′-one, 2-(diethylamino)-8-(diethylamino)-4-methyl-spiro[5H-(1)benzopyrano (2,3-d)pyrimidine-5,1′(3′H)isobenzofuran]-3′-one, 2-(di-n-butylamino)-8-(di-n-butylamino)-4-methyl-spiro[5H-(1) benzopyrano(2,3-d)pyrimidine-5,1′(3′H)isobenzofuran]-3′-one, 2-(di-n-butylamino)-8-(diethylamino)-4-methyl-spiro[5H-(1) benzopyrano(2,3-d)pyrimidine-5,1′(3′H)isobenzofuran]-3′-one, 2-(di-n-butylamino)-8-(N-ethyl-N-1-amylamino)-4-methyl-spiro[5H-(1)benzopyrano(2,3-d)pyrimidine-5,1′(3′ H)isobenzofuran]-3′-one, 2-(di-n-butylamino)-8-(di-n-butylamino)-4-phenyl, 3-(2-methoxy-4-dimethylaminophenyl)-3-(1-butyl-2-methylindol-3-yl)-4,5,6,7-tetrachlorophthalide, 3-(2-ethoxy-4-diethylaminophenyl)-3-(1-ethyl-2-methylindol-3-yl)-4,5,6,7-tetrachlorophthalide, and 3-(2-ethoxy-4-diethylaminophenyl)-3-(1-pentyl-2-methylindol-3-yl)-4,5,6,7-tetrachlorophthalide. Additional examples thereof include pyridine compounds, quinazoline compounds, and bisquinazoline compounds. These may also be used as mixtures of two or more kinds.

The color developer is an electron-accepting compound capable of giving a proton to the leuco dye. Examples thereof include phenols, metal salts of phenols, metal salts of carboxylic acids, aromatic carboxylic acids, aliphatic carboxylic acids having 2 to 5 carbon atoms, benzophenones, sulfonic acid salts, phosphoric acids, metal salts of phosphoric acids, acidic phosphoric acid esters, metal salts of acidic phosphoric acid esters, phosphorous acids, metal salts of phosphorous acids, monophenols, polyphenols, and 1,2,3-triazole and derivatives thereof. Additional examples thereof include those compounds substituted with an alkyl group, an aryl group, an acyl group, an alkoxycarbonyl group, a carboxy group or an ester thereof, an amide group, a halogen group or the like; and bis-type and tris-type phenols, phenol-aldehyde condensed resins, and metal salts thereof. These may also be used as mixtures of two or more kinds.

Specific examples include phenol, o-cresol, tert-butylcatechol, nonylphenol, n-octylphenol, n-dodecylphenol, n-stearylphenol, p-chlorophenol, p-bromophenol, o-phenylphenol, n-butyl p-hydroxybenzoate, n-octyl p-hydroxybenzoate, benzyl p-hydroxybenzoate; dihydroxybenzoic acid or an ester thereof, such as 2,3-dihydroxybenzoic acid or methyl 3,5-dihydroxybenzoate; resorcin, gallic acid, dodecyl gallate, ethyl gallate, butyl gallate, propyl gallate, 2,2-bis(4-hydroxyphenyl)propane, 4,4-dihydroxydiphenylsulfone, 1,1-bis(4-hydroxyphenyl)ethane, 2,2-bis(4-hydroxy-3-methylphenyl)propane, bis(4-hydroxyphenyl) sulfide, 1-phenyl-1,1-bis(4-hydroxyphenyl) ethane, 1,1-bis(4-hydroxyphenyl)-3-methylbutane, 1,1-bis(4-hydroxyphenyl)-2-methylpropane, 1,1-bis(4-hydroxyphenyl)-n-hexane, 1,1-bis(4-hydroxyphenyl)-n-heptane, 1,1-bis(4-hydroxyphenyl)-n-octane, 1,1-bis(4-hydroxyphenyl)-n-nonane, 1,1-bis(4-hydroxyphenyl)-n-decane, 1,1-bis(4-hydroxyphenyl)-n-dodecane, 2,2-bis(4-hydroxyphenyl)butane, 2,2-bis(4-hydroxyphenyl)ethyl propionate, 2,2-bis(4-hydroxyphenyl)-4-methylpentane, 2,2-bis(4-hydroxyphenyl)hexafluoropropane, 2,2-bis(4-hydroxyphenyl)-n-heptane, 2,2-bis(4-hydroxyphenyl)-n-nonane, 2,4-dihydroxyacetophenone, 2,5-dihydroxyacetophenone, 2,6-dihydroxyacetophenone, 3,5-dihydroxyacetophenone, 2,3,4-trihydroxyacetophenone, 2,4-dihydroxybenzophenone, 4,4′-dihydroxybenzophenone, 2,3,4-trihydroxybenzophenone, 2,4,4′-trihydroxybenzophenone, 2,2′,4,4′-tetrahydroxybenzophenone, 2,3,4,4′-tetrahydroxybenzophenone, 2,4′-biphenol, 4,4′-biphenol, 4-[(4-hydroxyphenyl)methyl]-1,2,3-benzenetriol, 4-[(3,5-dimethyl-4-hydroxyphenyl)methyl]-1,2,3-benzenetriol, 4,6-bis[(3,5-dimethyl-4-hydroxyphenyl)methyl]-1,2,3-benzene triol, 4,4′-[1,4-phenylenebis(1-methylethylidene)bis(benzene-1,2,3-triol)], 4,4′-[1,4-phenylenebis(1-methylethylidene)bis(1,2-benzenediol)], 4,4′,4″-ethylidenetrisphenol, 4,4′-(1-methylethylidene)bisphenol, and methylenetris-p-cresol.

In regard to the decolorizing agent, any known compound can be used as long as it is capable of inhibiting a color development reaction induced by a leuco dye and a color developer under the action of heat in a three-component system of a coloring compound, a color developer and a decolorizing agent, and rendering the system colorless.

For example, the decolorizing agent may exist in (1) a form in which a component that has developed a color as a result of the coupling of a leuco dye and a color developer, and a decolorizing agent component are dispersed in a medium which has no or negligible color-developing and decolorizing action; or (2) a form in which a decolorizing agent component is used as a medium for a component that has developed a color as a result of the coupling of a leuco dye and a color developer.

In regard to the decolorizing agent used in the form of (2), particularly those decolorizing agents disclosed in Japanese Patent Application Laid-Open (JP-A) No. 60-264285, JP-A No. 2005-1369, JP-A No. 2008-280523 and the like have a color-development and decolorization mechanism that utilizes hysteresis, which is excellent in terms of instantaneous decolorizability. When this three-component system mixture that has developed a color is heated to or above a particular decolorization temperature Th, the mixture can be decolorized. Furthermore, even if the decolorized mixture is cooled to a temperature equal to or lower than Th, the decolorized state is maintained. The decolorizing agent is capable of causing a reversible color development and decolorization reaction in which, when the temperature is further decreased, the color development reaction induced by the leuco dye and the color developer is restored at or below a particular color restoration temperature Tc, and the color-developed state is restored. Particularly, it is preferable that the decolorizing agent used in the present embodiment satisfy the relationship of Th>Tr>Tc, wherein Tr stands for room temperature.

Examples of the decolorizing agent that is capable of generating this temperature hysteresis include alcohols, esters, ketones, ethers and acid amides.

Particularly, esters are preferred. Specific examples thereof include a carboxylic acid ester containing a substituted aromatic ring, an ester of an aliphatic alcohol and a carboxylic acid containing an unsubstituted aromatic ring, a carboxylic acid ester containing a cyclohexyl group in the molecule, an ester of a fatty acid and an unsubstituted aromatic alcohol or phenol, an ester of a fatty acid and a branched aliphatic alcohol, dibenzyl cinnamate, heptyl stearate, didecyl adipate, dilauryl adipate, dimyristyl adipate, dicetyl adipate, distearyl adipate, trilaurin, trimyristin, tristearin, dimyristin, and distearin. These may also be used as mixtures of two or more kinds.

Next, as the decolorizing agent that is used in the form of (1), those decolorizing agents disclosed in JP-A No. 2000-19770 and the like can be used. Examples thereof include cholesterol, stigmasterol, pregnenolone, methylandrostenediol, estradiol benzoate, epiandrostene, stenolone, β-sitosterol, pregnenolone acetate, β-cholestarol, 5,16-pregnadien-3β-ol-20-one, 5α-pregnen-3β-ol-20-one, 5-pregnene-3β,17-diol-20-one-21-acetate, 5-pregnene-3β,17-diol-20-one-17-acetate, 5-pregnene-3β,21-diol-20-one-21-acetate, 5-pregnene-3β,17-diol diacetate, rockogenin, tigogenin, esmilagenin, hecogenin, diosgenin, cholic acid, cholic acid methyl ester, sodium cholate, lithocholic acid, lithocholic acid methyl ester, sodium lithocholate, hydroxycholic acid, hydroxycholic acid methyl ester, hyodeoxycholic acid, hyodeoxycholic acid methyl ester, testosterone, methyltestosterone, 11α-hydroxymethyltestosterone, hydrocortisone, cholesterol methyl carbonate, α-cholestanol, D-glucose, D-mannose, D-galactose, D-fructose, L-sorbose, L-rhamnose, L-fucose, D-ribodesose, α-D-glucose=pentaacetate, acetoglucose, diacetone-D-glucose, D-glucuronic acid, D-galacturonic acid, D-glucosamine, D-fructosamine, D-isosaccharic acid, vitamin C, erythorbic acid, trehalose, saccharose, maltose, cellobiose, gentiobiose, lactose, melibiose, raffinose, gentianose, melezitose, stachyose, methyl=α-glucopyranoside, salicin, amygdalin, euxanthic acid, cyclododecanol, hexahydrosalicylic acid, menthol, isomenthol, neomenthol, neoisomenthol, carbomenthol, α-carbomenthol, piperitol, α-terpineol, β-terpineol, γ-terpineol, 1-p-menthen-4-ol, isopulegol, dihydrocarveol, carveol, 1,4-cyclohexanediol, 1,2-cyclohexanediol, phloroglucitol, quercitol, inositol, 1,2-cyclododecanediol, quinic acid, 1,4-terpin, 1,8-terpin, pinol hydrate, betulin, borneol, isoborneol, adamantanol, norborneol, fenchol, camphor, and 1,2:5,6-diisopropylidene-D-mannitol.

The mixing proportions of the leuco dye, the color developer and the decolorizing agent may vary with the concentration, discoloration temperature, and the types of the respective components; however, the proportion of the color developer is in the range of 0.1 to 100 parts, preferably 0.1 to 50 parts, and more preferably 0.5 to 20 parts; and the proportion of the decolorizing agent is in the range of 1 to 800 parts, preferably 5 to 200 parts, and more preferably 5 to 100 parts, relative to one part of the leuco dye.

The preparation of a dispersion liquid of the first fine particles containing a binder resin can be carried out by an already known method. Examples of such a method include, in the case of a binder resin particle dispersion liquid, a polymerization method of polymerizing a monomer or a resin intermediate by emulsion polymerization, seed polymerization, mini-emulsion polymerization, suspension polymerization, interface polymerization, or in situ polymerization; a phase inversion emulsification method of softening a binder resin by using a solvent, an alkali or a surfactant or by heating to form an oil phase, adding an aqueous phase containing water as a main component, and thereby obtaining particles; and a mechanical emulsification method of softening a binder resin by using a solvent or by heating, and mechanically micronizing the binder resin in an aqueous medium using a high pressure type micronizer, a rotor-stator type stirrer or the like. In the case of a releasing agent particle dispersion liquid or a charge-controlled dispersion liquid, the dispersion liquid can be obtained by a mechanical micronization method of mechanically micronizing these materials in an aqueous medium using a high pressure type micronizer, a rotor-stator type stirrer, a media micronizer or the like.

The first fine particles can be obtained by, for example, subjecting a dispersion liquid of resin particles containing at least a binder resin, to mechanical shearing, and micronizing the resin particles to produce fine particles having a particle size that is smaller than the particle size of the resin particles.

As an example mechanical shearing, a specific example of a method of producing fine particles with a high pressure type micronizer, which is one of mechanical emulsification methods, will be described below.

First, coarsely granulated particles containing at least a binder resin are produced. The coarsely granulated particles can be obtained by, for example, a process of melt kneading a mixture containing a binder resin and a releasing agent, and coarse pulverizing the kneading product. The coarsely granulated particles preferably have a volume average particle size of 0.01 mm to 2 mm. If the volume average particle size is less than 0.01 mm, strong stirring is required to disperse the particles in an aqueous medium, and the foam generated by stirring tends to impede the dispersion of the mixture. If the volume average particle size is greater than 2 mm, since the particle size is larger than the gap provided at the shearing unit, the particles tend to clog the shearing unit, or particles having a non-uniform composition or a non-uniform particle size tend to be generated due to the difference in the amount of received energy between the inside and the outside of the mixture.

The coarsely granulated particles more preferably have a volume average particle size of 0.02 mm to 1 mm.

Next, the coarsely granulated particles are dispersed in an aqueous medium, and thereby a dispersion liquid of the coarsely granulated particles is formed.

In the process of forming a dispersion liquid of the coarsely granulated particles, a surfactant or an alkaline pH adjusting agent can be added to the aqueous medium.

When a surfactant is added, the coarsely granulated particles can be easily dispersed in an aqueous medium due to the function of the surfactant adsorbed to the particle surfaces. The binder resin and the releasing agent, which are both toner components, have low hydrophilicity, and without a surfactant, it is difficult to disperse the particles in water.

The concentration of the surfactant in this case is preferably equal to or higher than the critical micelle concentration. The critical micelle concentration refers to the lowest surfactant concentration required to form micelles in water, and can be determined by measuring the surface tension or the electrical conductivity. When a surfactant is contained in the dispersion liquid at a concentration equal to or higher than this critical micelle concentration, dispersion is further facilitated.

On the other hand, when an alkaline pH adjusting agent is added, the degree of dissociation of the dissociable functional group on the surface of the binder resin is increased, or polarity thereof is increased, and thereby, the self-dispersibility of the dispersion liquid can be enhanced.

Subsequently, the degassing of the dispersion liquid thus obtained is carried out according to necessity. Since the binder resin and the releasing agent, which are toner components, have low hydrophilicity, the toner can be dispersed in water by using a surfactant. However, at the time of mixing, foaming occurs significantly. When the micronization treatment is carried out in the subsequent process with a high pressure micronizer while this foam has been incorporated, cavitation occurs in the plunger of the high pressure pump, and the operation of the plunger becomes unstable. Particularly, in the case where, a plural number of plungers are linked in series to eliminate pulsating flow, since the operation of the plural plungers is under control, when cavitation occurs, the micronization treatment may not be achieved. Furthermore, because a high pressure type micronizer has a check valve, when foam is incorporated in the process liquid, particles are likely to adhere to this check valve, and clogging occurs at the check valve. When clogging occurs at the check valve, the process liquid cannot flow through, and the micronization treatment may not be achieved.

The method of degassing may be carried out by degassing in vacuo or under reduced pressure, centrifugal degassing, addition of a defoamant, or the like. Any method may be used as long as foam can be removed, but in the case of adding a defoamant, it is necessary to select a defoamant which does not affect the subsequent processes. Furthermore, it is also important that the defoamant does not remain behind in the toner and cause deterioration of the charging characteristics and the like. Degassing under reduced pressure is preferred as a simple method. A process liquid is fed into a pressure-resistant container having a stirrer, and degassing is carried out by reducing the pressure to about −0.09 MPa with a vacuum pump, while stirring the process liquid.

After this dispersion liquid is formed, the dispersion liquid may further be subjected to wet pulverization as necessary. When the particles are pulverized to make the particle size even smaller, the subsequent treatments may be stabilized.

An example of the high pressure type wet micronizer used in the present invention is presented in FIG. 4.

A high pressure type micronizer is an apparatus which micronizes particles by applying shear to the particles by passing the particles through a fine nozzle while a pressure of 10 to 300 MPa is applied by a high pressure pump.

As shown in the diagram, the high pressure homogenizer 210 shown as an example of the high pressure type wet micronizer includes a configuration having a hopper tank 201, a liquid delivery pump 202, a high pressure pump 203, a heating unit 204, a micronization unit 205, a depressurization unit 206, a cooling unit 207, and a depressurization unit 208 disposed in this order, and piping that connects the respective units. Meanwhile, the depressurization units 206 and 208 can be provided as necessary.

The hopper thank 201 is a tank to which a process liquid is fed. At the time of operating the apparatus, it is necessary to have the hopper tank filled with a liquid all the time so that air is prevented from entering the apparatus. When the particles in the process liquid have a large particle size and are likely to sediment, the hopper tank may be further provided with a stirrer.

The liquid delivery pump 202 is provided in order to continuously deliver the process liquid to the high pressure pump 203. Furthermore, the liquid delivery pump is also effective in avoiding clogging a check valve that is provided in the high pressure pump 203 but is not depicted in the diagram. As for this pump 202, for example, a diaphragm pump, a tubing pump, a gear pump or the like can be used.

The high pressure pump 203 is a plunger type pump, and has check valves at the process liquid inlet port and the process liquid outlet port, which are not depicted in the diagram. The number of plungers used in the pump may be from 1 to 10 in accordance with the production scale. It is desirable to have two or more plungers in order to minimize pulsating flow.

The heating unit 204 is provided with high pressure piping 209 which is formed in a spiral form so as to provide a large heat exchange area within a heating apparatus such as an oil bath. This heating unit 204 may be disposed at either the upstream side or the downstream side of the high pressure pump 203 with respect to the flow direction of the dispersion liquid, but it is necessary that the heating unit be at least in the upstream of the micronization unit 205. When the heating unit 204 is provided in the upstream of the high pressure pump 203, the hopper 201 may be provided with a heating apparatus; however, since the retention time under high temperature is lengthened, hydrolysis of the binder resin is prone to occur.

The micronization unit 205 includes a nozzle having holes with a very small diameter, which is intended for the application of strong shear. The nozzle diameter is preferably from 0.05 mm to 0.5 mm. Furthermore, in regard to the shape, a pass-through type nozzle or a collision type nozzle is desirable. Furthermore, this nozzle may be arranged in multiple stages, and in the case of providing multiple stages of nozzles, plural nozzles with different diameters may be arrayed. The array of plural nozzles may be in parallel or in series. As the material of the nozzle, diamond that can endure high pressure or the like may be used.

The cooling unit 207 is provided with piping 211 which is formed in a spiral form so as to take a large heat exchange area within a bath in which cold water is continuously flowing.

In configuration of the depressurization units 206 and 208 that are provided according to necessity, one or more of a cell having a flow channel with a diameter that is larger than the nozzle diameter of the micronization unit 205 and is smaller than the connection pipe diameter, or one or more two-way valves are arranged.

The treatment using this high pressure micronizer is carried out as follows.

First, a process liquid sent from the hopper tank 201 passes through the liquid delivery pump 202 and the high pressure pump 203, and is heated to a temperature equal to or higher than the glass transition temperature, Tg, of the binder resin at the heating unit 204. The purpose of heating the process liquid is to melt the binder resin.

This heating temperature may vary with the melt characteristics of the binder resin. A resin that easily melts can be used without any problem even at a low temperature, but a resin that does not easily melt requires a high temperature. Furthermore, in the case of a method of heating by continuously passing the process liquid through a heat exchanger, the heating temperature also affects the flow rate of the dispersion liquid and the length of the piping for heat exchange. When the flow rate is high or the piping is short, a high temperature is required. On the contrary, when the flow rate is low or the piping is long, the dispersion liquid is sufficiently heated, and thus a treatment at a low temperature is made possible. In the case where the flow volume is 300 to 400 cc/min; the heat exchanger piping is a high pressure pipe having a diameter of ⅜ inches and a length of 12 m; the Tg of the binder resin is 60° C.; and the softening point Tm of the toner is 130° C., the heating temperature may be from 100° C. to 200° C. The measurement of the softening point of the toner is carried out by a temperature elevation method with a flow tester, CFT-500, manufactured by Shimadzu Corp., and a point on the curve of the flow chart, which is equivalent to an amount of plunger fall of 2 mm, is designated as the softening point.

Next, this heated dispersion liquid is subjected to shear at the micronization unit 205 while a pressure of 10 MPa or higher is applied. At this time, the nozzle is used to provide the shear. When the dispersion liquid is passed through the nozzle while a high pressure of 10 MPa or higher is applied thereto, the molten toner components are micronized. The pressure at this time may be from 10 MPa to 300 MPa.

Finally, the dispersion liquid is cooled to a temperature equal to or lower than the glass transition temperature, Tg, of the binder resin at the cooling unit 207. Through this cooling, the molten fine particles are solidified. Since the process liquid is rapidly cooled, aggregation or coalescence due to cooling does not easily occur.

As discussed above, back pressure may be applied or depressurization may be carried out as necessary at the depressurization units 206 and 208, either before or after the cooling unit 207. Back pressure or depressurization implies that a process liquid is not exposed to the atmospheric pressure immediately after the passage through the nozzle, but the process liquid is returned to around the atmospheric pressure in one stage (back pressure) or in multiple stages (depressurization). The pressure after the passage through the back pressure unit or depressurization unit is 0.1 to 10 MPa, and desirably 0.1 to 5 MPa. This depressurization unit may be constructed by arranging a plural number of cells or valves having different diameters. By reducing the pressure in multiple stages, fine particles having a sharp particle size distribution with fewer coarse particles can be obtained.

A dispersion liquid of the first fine particles containing a binder resin can be obtained in the manner as described above.

Next, a specific example of a method of preparing a dispersion of first fine particles containing at least a binder resin, through emulsion polymerization, which is one of the polymerization methods, will be described.

First, an oil phase component is prepared by mixing a vinylic polymerizable monomer with a chain transfer agent as necessary. The oil component is emulsion dispersed in an aqueous phase component, which is an aqueous solution of a surfactant, and polymerization is carried out by adding a water-soluble polymerization initiator and heating the mixture. A releasing agent, a charge controlling agent and the like, which are toner components, may also be incorporated into the oil phase component. Alternatively, a dispersion prepared by dispersing fine particles of a releasing agent, a charge controlling agent and the like in an aqueous medium can be added during the polymerization process to incorporate these components into the emulsion polymerized particles. Through this emulsion polymerization, a dispersion of fine particles having a diameter of from 0.01 μm to 1 μm of the toner components containing at least a binder resin, can be produced. As to the method of this emulsion polymerization, polymerization may be carried out while the oil phase component is added dropwise to the aqueous phase component, or the polymerization initiator may be added again in the middle of the polymerization process for an adjustment of the molecular weight.

Next, a specific example of a method of preparing a dispersion of first fine particles containing at least a binder resin through a phase inversion emulsification method, will be described.

First, an oil phase component containing the toner components which include at least a binder resin, is heated and melted. An aqueous solution containing a surfactant and a pH adjusting agent is slowly added to the molten oil phase component. As the aqueous solution is added, phase inversion occurs from the W/O state to the O/W state. After completion of the phase inversion, the system is cooled, and thus a fine particle dispersion of toner components having a particle size of from 0.01 μm to 5 μm and containing at least a binder resin, can be prepared. Here, a surfactant, a pH adjusting agent, a solvent, ion-exchanged water and the like may be added in advance to the oil phase component, and particularly, if a solvent has been added, since the viscosity of the oil phase component decreases, heating may not be needed. However, when a solvent is used, it is necessary to remove the solvent after the phase inversion emulsification process.

Next, an example of a method of aggregating and fusing second fine particles which have been master batch-treated and contain at least a coloring compound such as a leuco dye, a color developer and a portion or the entire amount of a decolorizing agent, and first fine particles containing at least a binder resin, in a medium such as water, will be described below.

Here, the first fine particles containing at least a binder resin may be, for example, a mixture of fine particles of a binder resin, fine particles of a releasing agent and fine particles of a charge controlling agent, or may be fine particles in which a releasing agent or a charge controlling agent is included in a binder resin. Furthermore, the first fine particles may be a mixture of such particles.

First, an aggregating agent is added to a dispersion liquid of the first fine particles and the second fine particles. The amount of addition of the aggregating agent may vary with the dispersion stability of these respective fine particles. If the dispersion stability is high, the amount of addition may be large, and if the dispersion stability is low, the amount of addition may be small. Furthermore, the amount of addition of the aggregating may also vary depending on the type of the aggregating agent. In the case of using, for example, aluminum sulfate with high aggregating properties is used as the aggregating agent, this agent may be added in an amount of 0.1% to 50% by weight, and desirably 0.5% to 10% by weight, with respect to the fine particles. After the addition of the aggregating agent, fine particles having a particle size of 0.1 μm to 10 μm are obtained. On the other hand, for example, in the case of using an aggregating agent having weak aggregating properties, such as sodium chloride, occasionally aggregation may not occur upon the addition of the aggregating agent. At the time of addition of this aggregating agent, a dispersing machine of rotor-stator type may be used in order to prevent sudden aggregation of the fine particles. Similarly, in order to prevent sudden aggregation of the fine particles, the addition of a pH adjusting agent and a surfactant to the fine particle dispersion liquid may be carried out before the addition of the aggregating agent. The particle size of the finally obtained toner can be made uniform through these operations.

Subsequently, aggregation by heating is carried out. Aggregate particles having a particle size of from 2 μm to the target particle size are produced by heating.

Subsequently, fusion by heating is carried out. The aggregate particles are stabilized by adding stabilizers such as a pH adjusting agent and a surfactant as necessary to the aggregate particles, and then the aggregate particles are heated to a temperature at least equal to or higher than the glass transition temperature, Tg, of the binder resin. Thereby, the surfaces of the aggregate particles are fused. Through this fusion process, the final target particle size is obtained.

Depending on the type of the fine particles, the concentration of solid components, and the type of the aggregating agent, aggregation and fusion may be simultaneously achieved.

Furthermore, the stirring conditions in these processes of aggregation and fusion greatly affect the particle size and the particle size distribution. The condition for the stirring speed is such that a speed capable of providing appropriate shear is desired. If the shear is too weak, the particle size becomes large, and coarse particles are prone to occur. On the other hand, if the shear is too strong, the particle size becomes small, and minute particles are prone to occur. It is desirable to provide baffles in the reaction tank. Baffles have an effect of suppressing foaming, an effect of making the stirring state in the tank uniform, and an effect of intensifying shear. In addition to the stirring conditions, the rate of temperature increase, the feed rate of additives, and the like also largely affect the particle size and the particle size distribution.

The aggregate particle surfaces can be coated with a resin according to necessity. A first example of the method of coating may be a method of adding resin particles and the like to the dispersion liquid of aggregate particles, attaching the resin particles and the like to the surfaces of the aggregate particles through the addition of an aggregating agent or pH adjustment, and then fusing the resin particles and the like to the surfaces of the aggregate particles. A second example of the method of coating may be a method of adding a polymerizable monomer to a solution containing the aggregate particles, thereby covering or swelling the surfaces of the aggregate particles with the monomer, and then polymerizing the monomer. A third example of the method of coating may be a method of fusing the aggregate particles, subsequently washing and drying the particles, and mechanically attaching resin particles and the like to the surfaces of the fused particles using a hybridizer or the like.

Among these, the first method is simple and convenient, and toner particles with a high coverage can be obtained. The resin particles to be used for coating in this method can be obtained by the micronization method described above.

Through this coating, a color material or a releasing agent can be incorporated into the surfaces of the toner particles, and thus the stability of images on continuously fed paper sheets is enhanced.

After the fused aggregate particles are formed as described above, the particles are subjected to washing, solid-liquid separation, and drying, and thereby a powder of fused aggregate particles is obtained. An external additive is added to the powder, and thus a toner can be obtained.

A specific example of the production apparatus used in the method for producing a developer of the present embodiment will be described below.

There are no particular limitations on the kneading machine as long as it is capable of melt kneading, and examples thereof include a single-screw extruder, a twin-screw extruder, a pressure kneader, a Banbury mixer, and a Brabender mixer. Specific examples include FCM (manufactured by Kobe Steel, Ltd.), NCM (manufactured by Kobe Steel, Ltd.), LCM (registered trademark) (manufactured by Kobe Steel, Ltd.), ACM (manufactured by Kobe Steel, Ltd.), KTX (manufactured by Kobe Steel, Ltd.), GT (manufactured by Ikegai Corp.), PCM (manufactured by Ikegai Corp.), TEX (registered trademark) (manufactured by The Japan Steel Works, Ltd.), TEM (manufactured by Toshiba Machine Co., Ltd.), ZSK (manufactured by Werner & Pfleiderer Corp.), and Kneadex (manufactured by Mitsui Mining Co., Ltd.).

There are no particular limitations on the pulverizing machine as long as it is capable of performing pulverization in a dry manner, and examples thereof include a ball mill, an atomizer, a Bantam mill, a pulverizer, a hammer mill, a roll crusher, a cutter mill, and a jet mill.

There are no particular limitations on the micronizer as long as it is capable of micronization in a wet manner, and examples thereof include high pressure type micronizers such as a Nanomizer (manufactured by Yoshida Kikai Co., Ltd.), an Ultimizer (manufactured by Sugino Machine, Ltd.), a NANO3000 (registered trademark) (manufactured by Beryu Co., Ltd.), a Microfluidizer (manufactured by Mizuho Industrial Co., Ltd.), and a Homogenizer (manufactured by Izumi Food Machinery Co, Ltd.); rotor-stator type stirrers such as an Ultra-Turrax (manufactured by IKA Japan K.K.), a T.K. Auto Homo Mixer (manufactured by Primix Corp.), a T.K. Pipeline Homo Mixer (manufactured by Primix Corp.), a T.K. Filmix (registered trademark) (manufactured by Primix Corp.), a Creamix (registered trademark) (manufactured by M. Technique Co., Ltd.), a Crea SS5 (manufactured by M. Technique Co., Ltd.), Cavitron (manufactured by Euro-Tech Corp.), and a Fine Flow Mill (manufactured by Pacific Machinery & Engineering Co., Ltd.); and media stirrers such as a Visco Mill (manufactured by Aimex Co., Ltd.), an Apex Mill (manufactured by Kotobuki Industries Co., Ltd.), a Star Mill (manufactured by Ashizawa FineTech, Ltd.), a DCP Super Flow (manufactured by Nippon Eirich Co., Ltd.), an MP Mill (registered trademark) (manufactured by Inoue Manufacturing, Inc.), a Spike Mill (manufactured by Inoue Manufacturing, Inc.), a Mighty Mill (registered trademark) (manufactured by Inoue Manufacturing, Inc.), and an SC Mill (manufactured by Mitsui Mining Co., Ltd.). These micronizers can also be used when the toner component particles and the aggregating agent are mixed.

As the washing apparatus, for example, a centrifuge device, a filter press and the like are suitably used. As the washing liquid, for example, water, ion-exchanged water, purified water, acidically adjusted water, or basically adjusted water is used.

As the drying apparatus, for example, a vacuum dryer, an air jet dryer, or a fluidized dryer is suitably used.

In regard to the material used in the present embodiment, any agents that are known as toner materials, such as a polymerizable monomer, a chain transfer agent, a crosslinking agent, a polymerization initiator, a surfactant, an aggregating agent, a pH adjusting agent, a defoamant, a resin, and a releasing agent, can all be used.

Examples of vinylic polymerizable monomers include aromatic vinyl monomers such as styrene, methylstyrene, methoxystyrene, phenylstyrene, and chlorostyrene; ester-based monomers such as methyl acrylate, ethyl acrylate, butyl acrylate, methyl methacrylate, ethyl methacrylate, and butyl methacrylate; carboxylic acid-containing monomers such as acrylic acid, methacrylic acid, fumaric acid, and maleic acid; amine-based monomers such as aminoacrylate, acrylamide, methacrylamide, vinylpyridine, and vinylpyrrolidone; and derivatives thereof, and these can be used singly or as mixtures of plural compounds. Examples of polycondensate-based polymerizable monomers include, as alcohol components, aliphatic diols such as ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,4-butenediol, 1,2-propanediol, 1,3-butanediol, neopentyl glycol, and 2-butyl-2-ethyl-1,3-propanediol; aromatic diols such as alkylene oxide adducts of bisphenol A, such as polyoxypropylene(2.2)-2,2-bis(4-hydroxyphenyl)propane and polyoxyethylene(2.2)-2,2-bis(4-hydroxyphenyl)propane; polyhydric alcohols having a valency of 3 or higher, such as glycerin and pentaerythritol; and derivates thereof, and these can be used singly or as mixtures of plural compounds. Examples of carboxylic acid components include aliphatic dicarboxylic acids such as oxalic acid, malonic acid, maleic acid, fumaric acid, citraconic acid, itaconic acid, glutaconic acid, succinic acid, adipic acid, sebacic acid, azelaic acid, n-dodecylsuccinic acid, and n-dodecenylsuccinic acid; alicyclic dicarboxylic acids such as cyclohexanedicarboxylic acid; aromatic dicarboxylic acids such as phthalic acid, isophthalic acid and terephthalic acid; polyvalent carboxylic acids having a valency of 3 or higher, such as trimellitic acid and pyromellitic acid; and derivatives thereof, and these can be used singly or as mixtures of plural compounds.

Examples of the chain transfer agent that may be used include carbon tetrabromide, dodecylmercaptan, trichlorobromomethane, and dodecanethiol.

Examples of the crosslinking agent that may be used include compounds having two or more unsaturated bonds, such as divinylbenzene, divinyl ether, divinylnaphthalene, and diethyl glycol methacrylate.

In regard to the polymerization initiator, there is a need to use the initiators appropriately in accordance with the polymerization method, and there are two kinds of initiators, such as water-soluble initiators and oil-soluble initiators. Examples of the water-soluble initiators that may be used include persulfuric acid salts such as potassium persulfate and ammonium persulfate; azo-based compounds such as 2,2-azobis(2-aminopropane); hydrogen peroxide, and benzoyl peroxide. Furthermore, examples of the oil-soluble initiators that may be used include azo-based compounds such as azobisisobutyronitrile and azobisdimethylvaleronitrile; and peroxides such as benzoyl peroxide and dichlorobenzoyl peroxide. If necessary, a redox type initiator can also be used.

As the surfactant, an anionic surfactant, a cationic surfactant, an amphoteric surfactant, a nonionic surfactant, and the like can be used. Examples of the anionic surfactant include fatty acid salts, alkyl sulfuric acid ester salts, polyoxyethylene alkyl ether sulfuric acid ester salts, alkylbenzene sulfonic acid salts, alkylnaphthalene sulfonic acid salts, dialkyl sulfosuccinic acid salts, alkyl diphenyl ether disulfonic acid salts, polyoxyethylene alkyl ether phosphoric acid salts, alkenyl succinic acid salts, alkanesulfonic acid salts, naphthalene sulfonic acid-formalin condensate salts, aromatic sulfonic acid-formalin condensate salts, polycarboxylic acids, and polycarboxylic acid salts. Examples of the cationic surfactant include alkylamine salts, and alkyl-quaternary ammonium salts. Examples of the amphoteric surfactant include alkylbetaines, and alkylamine oxides. Examples of the nonionic surfactant include polyoxyethylene alkyl ether, polyoxyalkylene alkyl ether, polyoxyethylene derivatives, sorbitan fatty acid esters, polyoxyethylene sorbitan fatty acid esters, polyoxyethylene sorbitol fatty acid esters, glycerin fatty acid esters, polyoxyethylene fatty acid ethers, polyoxyethylene hardened castor oils, polyoxyethylene alkylamines, and alkylalkanolamides. These can be used singly or in combination of plural kinds.

Examples of the aggregating agent that can be used include monovalent salts such as sodium chloride, potassium chloride, lithium chloride, and sodium sulfate; divalent salts such as magnesium chloride, calcium chloride, magnesium sulfate, calcium sulfate, zinc chloride, ferrous chloride, and ferrous sulfate; and trivalent salts such as aluminum sulfate and aluminum chloride. Furthermore, organic coagulating agents or organic polymer coagulating agents such as quaternary ammonium salts, such as polyhydroxypropyldimethylammonium chloride and polydiallyldimethylammonium chloride, can also be used.

Examples of the pH adjusting agent that can be used include acids such as hydrochloric acid, sulfuric acid, nitric acid, acetic acid, citric acid, and phosphoric acid; and alkalis such as sodium hydroxide, ammonia, and amine compounds. Examples of the amine compounds include dimethylamine, trimethylamine, monoethylamine, diethylamine, triethylamine, propylamine, isopropylamine, dipropylamine, butylamine, isobutylamine, sec-butylamine, monoethanolamine, diethanolamine, triethanolamine, triisopropanolamine, isopropanolamine, dimethylethanolamine, diethylethanolamine, N-butyldiethanolamine, N,N-dimethyl-1,3-diaminopropane, and N,N-diethyl-1,3-diaminopropane. Furthermore, surfactants exhibiting acidity or alkalinity can also be used.

Examples of the defoamant include lower alcohol-based defoamants, organic polar compound-based defoamants, mineral oil-based defoamants, and silicone-based defoamants. Examples of the lower alcohol-based defoamants that can be used include methanol, ethanol, isopropanol and butanol. Examples of the organic polar compound-based defoamants that can be used include 2-ethylhexanol, amyl alcohol, diisobutylcarbinol, tributyl phosphate, oleic acid, tall oil, metal soaps, sorbitan lauric acid monoesters, sorbitan oleic acid monoesters, sorbitan oleic acid triesters, lower molecular weight polyethylene glycol oleic acid esters, low mole EO adducts of nonylphenol, pluronic type low mole EO adducts, polypropylene glycol, and derivatives thereof. Examples of the mineral oil-based defoamants that can be used include surfactant blends of mineral oil, and surfactant blends of mineral oil and fatty acid metal salts. Examples of the silicone-based defoamants that can be used include silicone resins, surfactant blends of silicone resins, and inorganic powder blends of silicone resins.

Examples of the binder resin include styrenic resins such as polystyrene, a styrene-butadiene copolymer, and a styrene-acrylic copolymer; ethylenic resins such as polyethylene, a polyethylene-vinyl acetate copolymer, a polyethylene-norbornene copolymer, and a polyethylene-vinyl alcohol copolymer; polyester resins, acrylic resins, phenolic resins, epoxy resins, allyl phthalate-based resins, polyamide resins, and maleic acid-based resins. These resins may be used singly, or two or more kinds may be used in combination. When these resins are polymerized, the polymerizable monomers, chain transfer agents, crosslinking agents, polymerization initiators and the like that have been described above can be used. The glass transition temperature of these resins may be in the range of 40° C. to 80° C., and the softening point thereof may be in the range of 80° C. to 180° C. Particularly, polyester resins having satisfactory fixability are desirable. Furthermore, polyester resins having an acid value of 1 or higher are preferred. When the resins have acid values, the effect of the alkaline pH adjusting agent is manifested in the process of micronization, and thus fine particles having a small particle size can be obtained.

Examples of the releasing agent include aliphatic hydrocarbon-based waxes such as a low molecular weight polyethylene, a low molecular weight polypropylene, a polyolefin copolymer, polyolefin wax, microcrystalline wax, paraffin wax, and Fischer-Tropsch wax; oxides of aliphatic hydrocarbon-based waxes, such as acid adducts of polyethylene wax, or block copolymers thereof; vegetable waxes such as candellila wax, carnauba wax, Japan wax, jojoba wax, and rice wax; animal waxes such as beeswax, lanolin, and spermaceti wax; mineral waxes such as ozokerite, ceresin, petrolactam; waxes containing fatty acid esters as main components, such as montanic acid ester wax and castor wax; and products obtained by deacidifying a portion or the entirety of fatty acid esters, such as deacidified carnauba wax. Furthermore, saturated chain fatty acids such as palmitic acid, stearic acid, montanic acid, and long-chain alkylcarboxylic acids having longer chain alkyl groups; unsaturated fatty acids such as brassidic acid, eleostearic acid, and parinaric acid; saturated alcohols such as stearyl alcohol, eicosyl alcohol, behenyl alcohol, carnaubyl alcohol, ceryl alcohol, myricyl alcohol, and long-chain alkyl alcohols having longer chain alkyl groups; polyhydric alcohols such as sorbitol; fatty acid amides such as linolic acid amide, oleic acid amide, and lauric acid amide; saturated fatty acid bisamides such as methylenebisstearic acid amide, ethylenebiscaproic acid amide, ethylenebislauric acid amide, and hexamethylenebisoleic acid amide; unsaturated fatty acid amides such as ethylenebisoleic acid amide, hexamethylenebisoleic acid amide, N,N′-dioleyladipic acid amide, and N,N′-dioleylsebacic acid amide; aromatic bisamides such as m-xylenebisstearic acid amide, and N,N′-distearylisophthalic acid amide; fatty acid metal salts (those generally called metal soaps) such as calcium stearate, calcium laurate, zinc stearate and magnesium stearate; waxes obtained by grafting vinylic monomers such as styrene or acrylic acid to aliphatic hydrocarbon-based waxes; partial esterification products of fatty acids and polyhydric alcohols, such as behenic acid monoglyceride; and methyl ester compounds having dihydroxyl groups, obtained by hydrogenating vegetable oils and fats.

As the charge controlling agent, for example, metal-containing azotized compounds are used, and complexes and complex salts having metal atoms of iron, cobalt and chromium, or mixtures thereof are desirable. In addition to those, metal-containing salicylic acid derivative compounds can also be used, and complexes and complex salts having metal atoms of zirconium, zinc, chromium and boron, or mixtures thereof are desirable.

Furthermore, a charge adjusting agent, an external additive, and the like can also be added according to necessity.

As an additive, inorganic fine particles can be added and incorporated to the toner particle surfaces in an amount of 0.01% to 20% by weight relative to the total weight of the toner, in order to adjust the fluidity or electrostatic properties of the toner particles. Examples of such inorganic fine particles include fine particles of silica, titania, alumina, strontium titanate, and tin oxide, and these can be used singly or as mixtures of two or more kinds. It is preferable to use inorganic fine particles which have been surface treated with a hydrophobizing agent, from the viewpoint of enhancing the environmental stability. In addition to such inorganic oxides, resin fine particles having a particle size of 1 μm or less may also be added as an external additive, for the purpose of enhancing cleanability.

Hereinafter, specific Examples and Comparative Examples of the production of toner particles related to the present embodiment will be described.

### EMBODIMENTS

Production of encapsulated and decolorizable colored fine particles (second fine particles)

In the following descriptions, the unit “part(s)” indicates part(s) by weight, while the unit “percent (%)” indicates percent by weight.

A component including one part of 3-(2-ethoxy-4-diethylaminophenyl)-3-(1-ethyl-2-methylindol-3-yl)-4-azaphthalide as a leuco dye, 5 parts of 2,2-bis(4-hydroxyphenyl)hexafluoropropane as a color developer, and 50 parts of a diester compound of pimellic acid and 2-(4-benzyloxyphenyl)ethanol as a decolorizing agent, was heated and melted. A solution prepared as an encapsulating agent by mixing 20 parts of an aromatic polyvalent isocyanate prepolymer and 40 parts of ethyl acetate was introduced into 250 parts of a 8% aqueous solution of polyvinyl alcohol, and the mixture was emulsion dispersed and continuously stirred for about one hour at 90° C. Subsequently, 2 parts of a water-soluble aliphatic modified amine was added thereto as a reaction agent, and while the liquid temperature was maintained at 90° C., the reaction liquid was continuously stirred for about 3 hours. Thus, colorless encapsulated particles were obtained. Furthermore, this dispersion of encapsulated particles was placed in a freezer to develop a color, and the dispersion was subjected to solid-liquid dispersion and was dried. Thus, colored particles A having blue color were obtained. These colored particles A were analyzed with SALD7000 manufactured by Shimadzu Corp., and the volume average particle size was 2 μm. Furthermore, the complete decolorization temperature, Th, was 79° C., and the complete color development temperature, Tc, was −10° C.

### Preparation of Master Batch Dispersion Liquid of Color Material (Second Fine Particles)

50 parts of the color material, and 50 parts of an ester wax (melting point 70° C.) as a master batch material (binder resin) were mixed, and then the mixture was melt kneaded in a twin-screw kneading machine with the temperature set at 80° C. Thus, a kneading product was obtained. The kneading product thus obtained was subjected to coarse pulverization with a hammer mill manufactured by Nara Machinery Co., Ltd., to obtain a volume average particle size of 1.2 mm. Thus, coarse particles were obtained. The coarse particles were subjected to medium pulverization with a Bantam mill manufactured by Hosokawa Micron, Ltd., to obtain a volume average particle size of 0.05 mm, and thus medium-pulverized particles were obtained. 30 parts of the medium-pulverized particles, 1.2 parts of sodium alkylbenzenesulfonate as an anionic surfactant, 1 part of triethylamine as an amine compound, and 67.8 parts of ion-exchanged water were treated using NANO3000 at 160 MPa and 120° C. Thus, a dispersion liquid of particles having a volume average particle size of 350 nm was prepared.

Preparation of Dispersion Liquid of Resin Fine Particles (First Fine Particles)

30 parts of a polyester resin as a binder resin, 1.5 parts of sodium dodecylbenzenesulfonate as an anionic surfactant, 1 part of triethylamine as an amine compound, and 67.5 parts of ion-exchanged water were treated using NANO3000 at 160 MPa and 150° C., and thus a dispersion liquid of particles having a volume average particle size of 150 nm was prepared.

Production of Toner Particles

3 parts of the color material master batch dispersion liquid, 17 parts of the resin fine particle dispersion liquid, and 75 parts of ion-exchanged water were mixed, and then 5 parts of a 5% aqueous solution of aluminum sulfate as an aggregating agent was added thereto at 30° C. After the addition of the metal salt, the temperature was increased to 40° C., and the reaction liquid was left to stand for one hour. Subsequently, 10 parts of a 10% aqueous solution of polycarboxylic acid sodium salt was added thereto. Subsequently, the temperature was increased to 75° C. and the reaction liquid was left to stand for one hour.

After cooling, the solid component of the dispersion liquid thus obtained was repeatedly subjected to centrifugation using a centrifuge, removal of the supernatant, and washing with ion-exchanged water, and washing was performed until the conductivity of the supernatant reached 50 μS/cm. Thereafter, the solid component was dried in a vacuum dryer until the water content reached 1.0% or less, and thus toner particles were obtained (volume D50: 8 μm).

Furthermore, 2 parts of hydrophobic silica and 0.5 parts of titanium oxide were added to the toner particles, and the mixture was mixed in a Henschel mixer and then was passed through a #200-mesh sieve. Thus, a toner was obtained. Because the toner thus produced is decolorized by the heat of the kneading process, the toner was stored and cooled in a freezer at −20° C. for 2 days to allow the toner to redevelop the color.

The toner thus obtained was mixed with a ferrite carrier coated with a silicone resin, and image printing was carried out with a multifunction printer (MFP) (e-Studio 4520C (registered trademark)) manufactured by Toshiba Tec Corp. The temperature of the fixing machine was set at 75° C., the paper feed rate was adjusted to 30 mm/sec, and color-developed images with an image density of 0.52 were obtained (measured with a Macbeth Image Densitometer RD-918). When the temperature of the fixing machine was raised to 90° C., decolorization was initiated, and the image density started to decrease. However, the fixing-possible temperature range could be secured at from 70° C. to 90° C.

A life test of 20,000 sheets was carried out using this developer (toner and carrier) at a set fixing temperature of 80° C. The images were stable, and there was neither a decrease in the image density nor contamination of white paper. Furthermore, the failure of thinning of the images by fixing was not observed. When the toner was observed with a scanning electron microscope (SEM), it could be confirmed that the color material (second fine particles) was neatly dispersed inside the toner particles.

### Comparative Example 1

The production of the encapsulated and decolorizable colored fine particles (second fine particles) was carried out in the same manner as in Embodiment 1.

Preparation of Dispersion Liquid of Color Material (Second Fine Particles)

30 parts of the encapsulated color material that had been prepared and dried, 1.2 parts of sodium alkylbenzenesulfonate as an anionic surfactant, 1 part of triethylamine as an amine compound, and 67.8 parts of ion-exchanged water were uniformly mixed, and thus a dispersion liquid of the color material was prepared.

Preparation of Wax Dispersion Liquid

30 parts of an ester wax (melting point 70° C.), 1.2 parts of sodium alkylbenzenesulfonate as an anionic surfactant, 1 part of triethylamine as an amine compound, and 67.8 parts of ion-exchanged water were uniformly mixed, and the mixture was treated using NANO3000 at 160 MPa and 120° C. Thus, a wax dispersion liquid of particles having a volume average particle size of 350 nm was prepared.

Production of Toner Particles

1.5 parts of the color material dispersion liquid, 1.5 parts of a wax, 17 parts of the resin fine particle dispersion liquid, and 75 parts of ion-exchanged water were mixed, and then 5 parts of a 5% aqueous solution of aluminum sulfate was added thereto at 30° C. Thereafter, the production process was carried out in the same manner as in Embodiment 1, and thus a toner having a particle size of 8 μm was obtained.

The toner thus obtained was mixed with a ferrite carrier coated with a silicone resin in the same manner as in Embodiment 1, and image printing was carried out using a multifunction printer (MFP) (e-Studio 4520C) manufactured by Toshiba Tec Corp. At a fixing temperature of 75° C., the image density was as low as 0.42, and a sufficient image density could not be obtained. When the fixing temperature was raised to 90° C., decolorization proceeded, and the image density decreased to 0.28. The fixing-possible temperature range where decolorization did not occur was from 70° C. to 84° C.

Continuous paper feed was carried out at a set fixing temperature of 77° C. using this developer (toner and carrier). It could been seen that the images obtained after fixing started to decolorize at a frequency of several times after the passage of a dozen or more sheets. A life test of 20,000 sheets was carried out, and the image density gradually decreased and reached a value as low as 0.35. Furthermore, fogging in white paper was extensively observed. Cleaning failure of images was also observed, and when an observation of the surface of the photoreceptor was made, many detached color material particles could be seen. Furthermore, when the toner particles were observed with a SEM, many color material particles that had floated or detached from the surface without being covered with the toner binder, were observed.

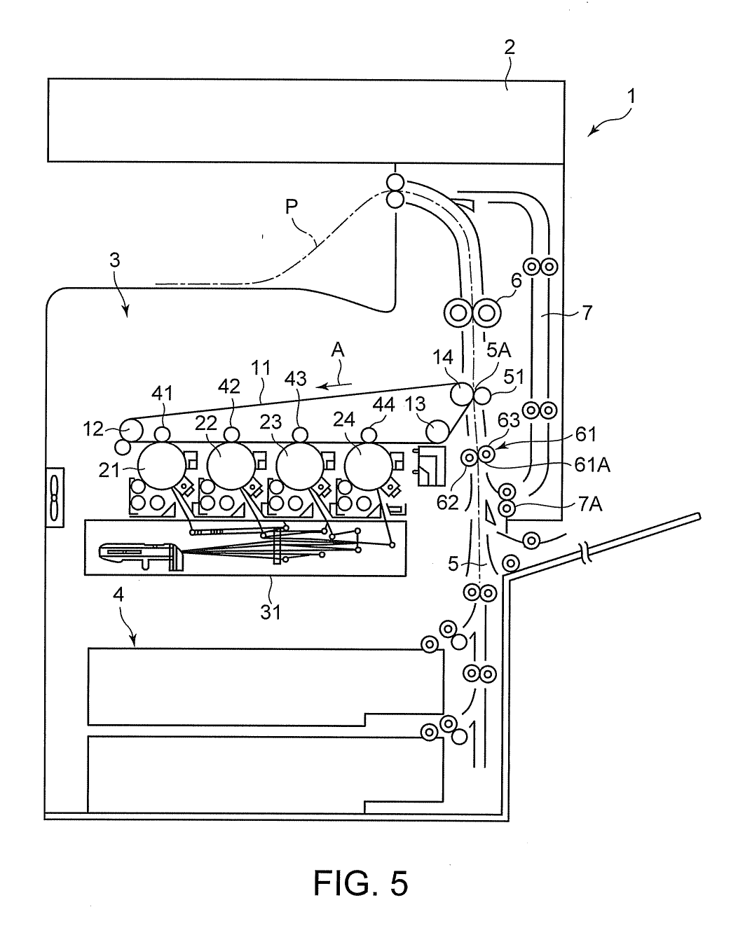

An image forming apparatus in which the developer according to the embodiment of the present invention can be applied, will be described below. FIG. 5 is a schematic configuration diagram of the image forming apparatus.

The image forming apparatus 1 shown in FIG. 5 includes a scanner section 2 that reads the image information of an original copy as the brightness and darkness of light, and forms an image signal; and an image forming section 3 that performs image printing by transferring an output image which is based on the image signal and has been visualized by the developer, that is, the toner, to a non-transfer medium used in image printing, that is, paper P. which is called a photocopy or a printout.

The image forming section 3 is provided with a paper holding section 4 that is composed of plural paper cassettes which respectively hold an arbitrary number of paper sheets of different predetermined sizes and are capable of supplying one sheet of paper each time. In the image forming section 3, paper P of the desired size is supplied from the paper holding section 4 on time with the formation of an output image.

Between the paper holding section 4 and the image forming section 3, there is provided a conveyance path 5 that operates as a paper conveying unit which guides the paper P from the paper holding section 4 toward the image forming section 3. As will be described later, the conveyance path 5 conveys the paper P, via a transfer position 5A where the toner image formed in the image forming section 3 is transferred, to a fixing device 6 in which the toner image that has been transferred on the paper P is fixed onto the paper P.

The image forming section 3 has, for example, an intermediate transfer belt 11 which is an insulating film having a predetermined thickness is formed in a belt form. The intermediate transfer belt 11 is subjected to a predetermined tension by a driving roller 12, a first tension roller 13 and a second tension roller 14, and as the driving roller 12 rotates, an arbitrary position on the belt that is in parallel to the axial line of the driving roller 12 moves in the direction of the arrow A. In other words, the intermediate transfer belt 11 is such that the belt surface is circulated in one direction at a speed at which the outer peripheral surface of the driving roller 12 moves.

In the zone where the belt surface of the intermediate transfer belt 11 moves substantially in a plane, a first to fourth image forming units 21, 22, 23 and 24 are disposed at a predetermined interval. In the example shown in FIG. 5, in the zone where the intermediate transfer belt 11 moves substantially in a plane between the driving roller 12 and the first tension roller 13, a first image forming unit 21 is located on the side of the driving roller 12, and a fourth image forming unit 24 is located on the side of the first tension roller 13.

Each of the first to fourth image forming units 21 to 24 includes at least a developing device which accommodates a color toner of cyan (C), magenta (M), yellow (Y) or black (BK) and a carrier; a photoreceptor, for example, a photoreceptor drum, which retains an electrostatic image to be developed by each of the developing devices. In the photoreceptor of each of the image forming units, a color electrostatic image to be developed by the developing device in each of the image forming units is formed by the imagewise light produced from an exposure device 31, and the toner is supplied to the corresponding developing device, thereby image development being achieved.

While the intermediate transfer belt 11 is interposed between one and another of the first to fourth image forming units 21 to 24, transfer rollers 41 to 44 are correspondingly provided on the rear surface side of the intermediate transfer belt 11, and the transfer rollers are intended to transfer the toner images, which are developed images obtained by developing the electrostatic images by the developing devices on the respective photoreceptors of the image forming units, onto the intermediate transfer belt 11. In each of the image forming units 21 to 24, electrostatic images are formed in sequence on the respective photoreceptors at predetermined time points such that the toner images to be sequentially transferred are superimposed on the intermediate transfer belt 11, and the electrostatic images are developed by the developing devices.

The toner images that have been superimposed on the intermediate transfer belt 11 by the action of the transfer rollers 41 to 44, to which different transfer voltages are respectively applied, are transferred to the paper P that is conveyed to the transfer position 5A, by a transfer roller 51 which is brought into contact with the intermediate transfer belt 11 at a predetermined pressure, at the transfer position 5A of the conveyance path 5. Here, when the transfer of the toner image to the paper P is not required, the transfer roller 51 is located by a roller lift device that is not depicted, to a shelter position where the transfer roller 51 will not be brought into contact with the intermediate transfer belt 11.

The toner image that has been transferred onto the paper P is fixed by the fixing device 6, and then the paper P is discharged to the paper discharge section.

The developer produced by the production method according to the present embodiment can be used in the image forming apparatus such as described above. Developers that are suitable for image forming apparatuses of this type are developers composed of a toner and a carrier (two-component developer), but in addition to them, developers composed mainly of a toner without including a carrier (one-component developer) are also available.

When the method for producing the developer illustrated in the above-described embodiment is used, a high quality toner which has a color material and resin particles dispersed uniformly, and has satisfactory decolorization performance, can be obtained.

An embodiment of the present invention has been described above, but this embodiment is only for illustrative purposes and is not intended to limit the scope of the invention by any means. This novel embodiment can be carried out in various forms, and various deletions, substitutions and modifications can be carried out to the extent that the gist of the invention is maintained. This embodiment and modifications thereof are definitely included in the spirit or scope of the invention, and are also included in the scope of the invention as defined by the appended claims and their equivalents.

What is claimed is:

1. A method for producing a developer, the method comprising:
aggregating first fine particles and second fine particles in a dispersion liquid, said dispersion liquid containing the first fine particles which contain at least a binder resin, and the second fine particles which contain a coloring compound, a color developer and a decolorizing agent and have been subjected to a master batch treatment; and
forming aggregate particles.

2. The method for producing a developer according to claim 1, wherein the second fine particles are encapsulated fine particles having a core component that contains a coloring compound, a color developer and a decolorizing agent, and a shell component that encapsulates the core component.

3. The method for producing a developer according to claim 1, wherein the second fine particles are subjected to the master batch treatment by melt kneading the second fine particles and a binder resin, and the second fine particles are preliminarily dispersed.

4. The method for producing a developer according to claim 3, wherein the second fine particles are fine particles which are decolorized when heated to a temperature equal to or higher than the decolorization temperature, and develops a color when cooled to a temperature equal to or lower than the color restoration temperature.

5. The method for producing a developer according to claim 4, wherein the master batch treatment of the second fine particles comprises melt kneading the second fine particles with the binder resin at a temperature lower than the decolorization temperature.

6. The method for producing a developer according to claim 1, wherein the coloring compound comprises a leuco dye, and the aggregate particles are further heated and fused to obtain toner particles, subsequently the color development of the leuco dye is checked, and if the toner particles have not sufficiently developed a color, the toner particles are further cooled.

7. A developer obtained by aggregating first fine particles and second fine particles in a dispersion liquid containing the first fine particles that contain at least a binder resin and the second fine particles that contain a coloring compound, a color developer and a decolorizing agent and have been subjected to a master batch treatment, and forming aggregate particles.

8. The developer according to claim 7, wherein the second fine particles are encapsulated fine particles having a core component that contains a coloring compound, a color developer and a decolorizing agent, and a shell component that encapsulates the core component.

9. The developer according to claim 7, wherein the second fine particles are subjected to a master batch treatment by melt kneading the second fine particles and a binder resin, and preliminarily dispersing the second fine particles.

10. The developer according to claim 7, wherein the master batch treatment of the second fine particles comprises melt kneading the second fine particles with the binder resin, said binder resin has high affinity for both the first fine particles and the second fine particles and have a melting point lower than a fixing temperature.

11. The developer according to claim 10, wherein said binder resin is one selected from a low molecular weight polyethylene wax, a polypropylene wax, a paraffin wax, and an ester wax.

12. The developer according to claim 7, wherein said coloring compound is a leuco dye which is an electron-donating compound capable of developing a color under the action of the color developer, said color develop is an electron-accepting compound capable of giving a proton to the leuco dye and said decolorizing agent is capable of inhibiting a color development reaction induced by the leuco dye and the color developer under the action of heat
